(19) United States
(12) Patent Application Publication
(10) Pub. No.: US 2021/0348423 A1
(43) Pub. Date: Nov. 11, 2021

(54) Positionally Variable Foot-Operated Door Opener and Closer

(71) Applicant: Vincent Stephenson Brown, Nashville, TN (US)

(72) Inventor: Vincent Stephenson Brown, Nashville, TN (US)

(21) Appl. No.: 16/871,998

(22) Filed: May 11, 2020

(51) Int. Cl. E05B 53/00; E05B 1/00

(52) U.S. Cl. CPC E05B 53/001; E05B 1/0038; E05B 1/0015

(57) ABSTRACT

A foot-operated door opening/closing/latching device is disclosed, including at least a single piece of material having a base member and an extension member; wherein the base member is configured to be attachable to a bottom surface of a door; wherein the extension member, which does not protrude below the bottom surface of the door, includes at least a first portion arcing upwardly, a second portion arcing downwardly, and a third portion arcing upwardly, configured to be engaged by a top, bottom or a side portion of a user's shoe such that when at least one of a downward, upward or sideward force is applied by said portion of said shoe, respectively, to the extension member, the door pulls open or closed; and the door opener/closer/latch is attachable to a door in such a manner that the door opener/closer/latch traverses one or more tracks or grooves formed in the base member.

### FIELD OF THE INVENTION

The present invention relates generally to foot-operated door openers, and in particular though non-limiting embodiments, to a foot-operated door opener and closer that can be attached to a conventional door, an existing partition door, certain sliding doors, a screen door, etc., and enable a user to partially or fully open or the door utilizing the top, bottom or side of the user's foot or shoe.

### BACKGROUND

Hand and foot-operated door opening devices are known in the art. Foot-operated door opening devices that do not use a person's hand or arm (as opposed to conventional doorknobs or handles) have existed in the art for over one-hundred years. Early models involved simple hook screws mounted to the bottom of a screen door, enabling a user to pull the door open with the user's foot. Furthermore, early models were designed for use with a light screen door. Typically, the user would place their toe under the device to pull open the door.

More recent models are similar in design and function with a similar downward shaped hook or downward angled piece of material, but their sturdier design characteristics enable the opening of heavier doors.

Foot-operated door openers provide sanitary benefits by enabling a user to open a door without hand contact with potentially germ, virus and/or bacteria-contaminated door handles, particularly in public restrooms and other public spaces. The need for improved sanitation and hands-free hardware, especially in public spaces has become especially important since the arrival of the COVID-19 virus and other such scourges.

Previous attempts at foot-operated door openers included devices with shapes that would promote entanglement with shoe laces or clothing material like pant legs and cuffs due to the sharp downward angle of the hook for the toe to engage under or could trap a user's foot if the door was opened from the other side while the user was attempting to use the device.

Despite the efforts of the prior art, a need still exists for a sanitary foot-operated door opener with a design that enables the user to use not just the toe of the shoe to pull open a door, but also enables the user to use the bottom of the foot or shoe sole to push down on the sanitary foot-operated door opener in order to open a door, or even use the side of a shoe to leverage the door open or close from beside. This is specifically necessary when an open-toe shoe or sandal or a delicate or ornamental shoe is worn in order to prevent damage to the shoe or injury to the toes.

Additionally, such an opener is desirable for persons with physical limitations that may not easily be able to pull upward with their toes due to medical-related foot or leg or lower body injuries. Furthermore, using one's toe when wearing an open-toe shoe or sandal would negate the sanitary aspect of the foot-operated door opener if one could not use the sole of his shoe instead.

There is, therefore, a long-standing yet unmet need for improved foot-operated door openers that overcome the deficiencies in the prior art.

### SUMMARY

A foot-operated door opening/closing/latching device is disclosed, including at least a single piece of material having a base member and an extension member; wherein the base member is configured to be attachable to a bottom surface of a door; wherein the extension member, which does not protrude below the bottom surface of the door, includes at least a first portion arcing upwardly, a second portion arcing downwardly, and a third portion arcing upwardly, is configured to be engaged by a top, bottom or a side portion of a user's shoe such that when at least one of a downward, upward or sideward force is applied by said portion of said shoe, respectively, to the extension member, said door pulls open or closed; and wherein the door opener/closer/latch is attachable to a door in such a manner that the door opener/closer/latch laterally traverses one or more tracks or grooves formed in the base member.

An alternative door opener/closer/latcher is also provided wherein an extension member is configured to be engaged by a user's shoe at a side surface of said extension member such that when a lateral or vertical force is applied to the side, top or bottom surface, and the door opener/closer/latch traverses an associated track or groove, thereby achieving lateral or vertical displacement and admitting to engagement with a neighboring hardware installation.

### BRIEF DESCRIPTION OF THE DRAWINGS

FIG. 1 illustrates a front view of a door opening/closing/latching device according to example embodiments.

FIG. 2 illustrates a side view of a door opener/closer/latch mounted to a door according to example embodiments.

FIG. 3a illustrates a side view of a door opener/closer/latch in use, whereby the user utilizes the top of his foot to open the door, according to example embodiments.

FIG. 3b illustrates a side view of a door opener/closer/latch in use, whereby the user utilizes the bottom of his foot to open the door, according to example embodiments.

FIG. 3c illustrates a side view of a door opener/closer/latch in use, whereby the user utilizes the top of his foot to hold the door open, according to example embodiments.

FIG. 3d illustrates a side view of a door opener/closer/latch in use, whereby the user utilizes the bottom of his foot to hold the door open, according to example embodiments.

FIG. 4 illustrates a side view of a door opener/closer/latch in use according to example embodiments.

FIG. 5 is a side isometric view of a door opener/closer/latch according to example embodiments.

FIG. 6a is a front plan view of a door opener/closer/latch according to example embodiments.

FIG. 6b is a side plan view of a door opener/closer/latch according to example embodiments.

FIGS. 7a and 7b is a plan view of an example embodiment in which the door opener/closer/latch can be engaged and either horizontally or vertically traverse a track or groove in order to engage other mounted hardware disposed on a neighboring partition or the like.

### DESCRIPTION

According to example embodiments, a sanitary and hands-free foot-operated door opener/closer/latch is provided that attaches to the bottom of a door of a range of widths, spring tensions, and door weights. The door opener/closer/latch can be engaged on one or more of a top surface, a bottom surface and a side surface to either push or pull a door open or closed, or horizontally slide left or right, or vertically slide up or down. The six-way variable positioning and top/bottom/left/right contact surfaces, when engaged with a user's foot or shoe, admits to a simple continuous motion for opening/closing and latching/unlatching in any direction. According to example embodiments, the door opener/closer/latch enhances the sanitary nature of a standard foot-operated door opener/closer/latch by enabling the user to use the bottom of the user's foot or shoe sole as the contact point with the door, as well as the side of the foot when standing beside the device. Certain embodiments enable the user to use a top surface of the user's foot or foot covering as the contact point with the door. According to other embodiments, the door opener/closer/latch's smooth and rounded design protects the user when the door to which the opener is attached is opened by someone on the other side of the door during operation. In still further embodiments, the smooth and rounded design prevents entanglement with the user's clothing or objects they might be carrying during use and leaves the user's shoe free if the door is opened from the other side. Furthermore, according to example embodiments, the design allows the foot-operated opening device to be used as a door stop to protect the wall when the door has been fully opened. In still further embodiments, the flexible design provides for leverage against the top or bottom of the user's shoe or foot. According to exemplary embodiments, the door opener/closer/latch is very easily installed, and relatively inexpensive to produce.

According to further embodiments, the door opener/closer/latch is attached to typical doors including non-sprung doors ranging in size and thickness typically from 24″ to 36″ in width, for both light weight and heavy doors. When a door does not have an automatic closing device, or a tension-adding device, which automatically closes the door, the foot-operated opener/closer/latch is used to close the door after entering. The curved arc along the design allows the engagement with a left-right action, along with a push-pull action delivered in a single continuous motion from a single contact with user's foot or shoe wherein, after closing the door with the opener/closer/latch device, the device can then latch the door, thereby preventing unwanted entry from the other side. According to example embodiments, this foot-operated door opener/closer/latch allows the user to initiate the opening of the door by using either the top of his foot or shoe, or by using the bottom of his foot or shoe sole, as well as the side surface of the foot or shoe. The ability to use the top, bottom or side of the shoe or foot ensures compatibility and function with open or closed toe shoes and persons who may have physical limitations or injury to their feet or lower body. The ability to use the bottom of the shoe sole also allows operation by delicate shoes, and avoids damage to the top of the shoe surface.

According to still further embodiments, the foot-operated door opener/closer/latch enables the user to avoid hand contact with the door for sanitary reasons when opening the door, or closing or latching the door. Other example embodiments provide hands-free opening, closing and latching for home or commercial use when a person has their hands full carrying items. Embodiments are engaged not only from the top or bottom but also from either side, which is beneficial in confined spaces and may be more comfortable for some users with physical or medical limitations. The side surfaces or side edge surfaces enable a user to pull a door open or close a door from a side angle to the door. This enables door opening in limited space situations when only partial reach is available. Having a side surface also enables the user to maintain voluntary contact with the device in order to hold the door open once pulled, if necessary. The ability to maintain contact with any of the surfaces also allows the latching in a single continuous motion.

According to a still further embodiment, the device is designed to traverse one or more lateral or vertical slots or tracks as would be formed if the device were mounted to a door with the attachment means (e.g., a set of screws of the like), so that the door opener/closer/latch preserves the flexibility of opening angles (whether top, bottom, or side) while admitting to a lateral or vertical repositioning using only the foot so that the opener can engage neighboring hardware such as a locking mount installed on an existing partition such as a bathroom door or the like. In this manner, a latch, pin or mated sliding piece can engage and cooperate with the door opener/closer/latch and lock the door without the user touching the door with their hands.

According to example embodiments, the foot-operated door opener/closer/latch is made of strong durable material that has a pretension quality that allows the material to maintain the primary shape while still have a degree of flexibility. In further embodiments, the material is stainless steel, aluminum, brass, copper, or plastic. In still further embodiments, the material is a composite, or a plastic, including recycled materials, and may include other materials for strength such as carbon fiber or Kevlar.

In example embodiments, the foot-operated door opener/closer/latch is made from a single piece of durable material and is in the shape of a smooth wave that allows the foot or shoe to comfortably slide in and out and on and off of the opener without damage to the person's foot or shoe. In further embodiments, the overall side-to-side shape is in a smooth arc, extending from the door mounting. This shape prevents the user from hindrance during operation due to the catching of clothing or shoelaces or any similar item or object that the person may be carrying or wearing. In example embodiments, the foot-operated door opener/closer/latch easily mounts to the lower door surface area by use of screws or bolts fastened through the opener material utilizing pre-existing holes and into the door material.

According to example embodiments, the foot-operated door opener/closer/latch utilizes a unique curved design, along with the durable slightly flexible material to provide opposing tension to the user's bottom of his shoe or foot, or to the top of the user's shoe or foot, which naturally aids in keeping the door opener/closer/latch in contact with the user's foot during operation.

In still further embodiments, the foot-operated door opener/closer/latch serves as a door stopper when the door to which it is attached is fully opened, eliminating the need for a separate door stopping device to protect the wall.

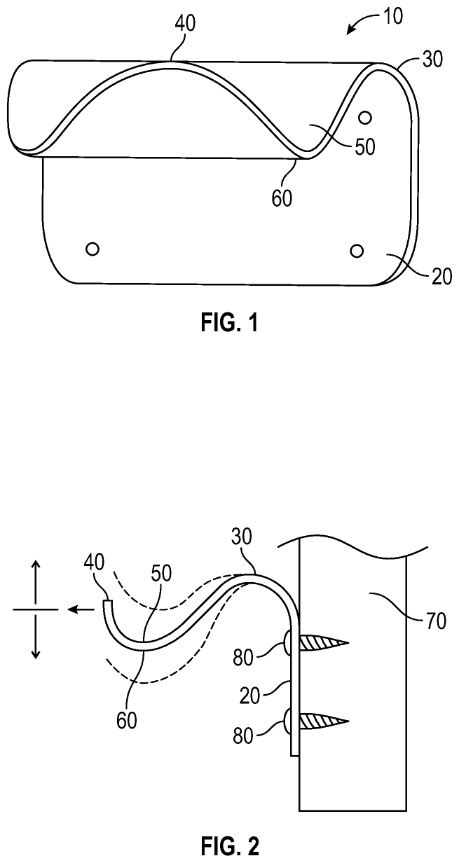

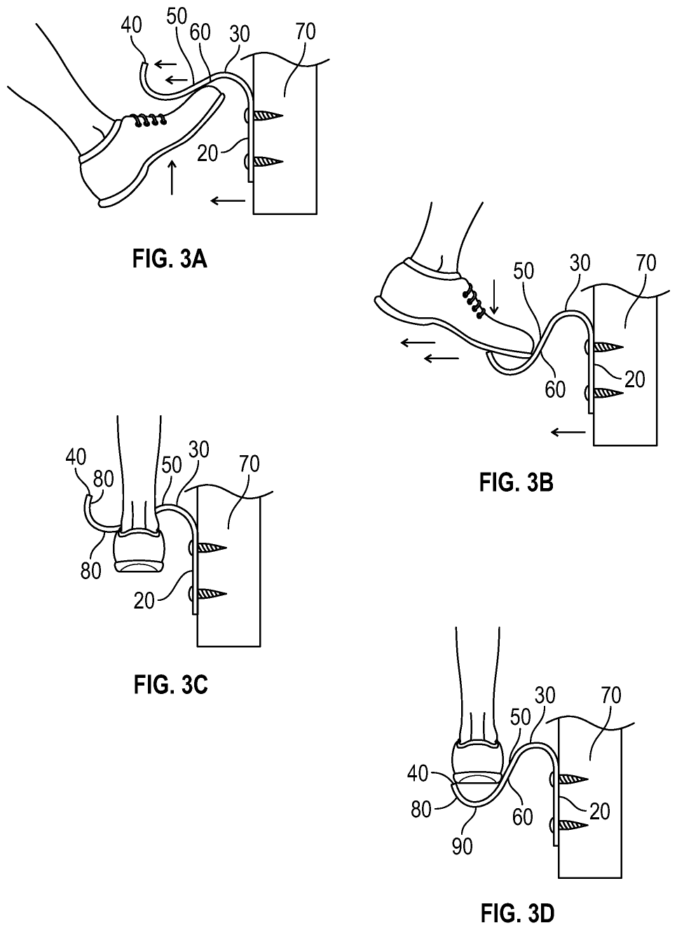

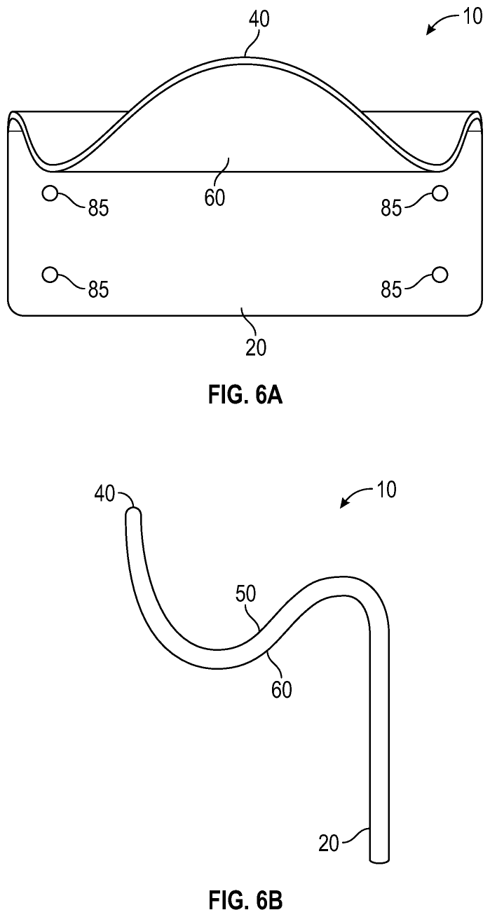

In FIGS. 1 and 5, an example embodiment of a door opener/closer/latch 10 is illustrated having a wave shaped extension 30 extending from a base portion 20. In base portion 20 a plurality of fastener apertures 85 are provided through which screws or similar attachment means may be passed to secure door opener/closer/latch 10 to a door. See, e.g. FIG. 2. Extension 30 has a top surface 50, a bottom surface 60, and a rounded end 40. Door opener/closer/latch 10 may be made of a durable material that allows for slight bending or displacement of extension 30 by a force applied to the top surface 50 or bottom surface 60. See, e.g., FIG. 2.

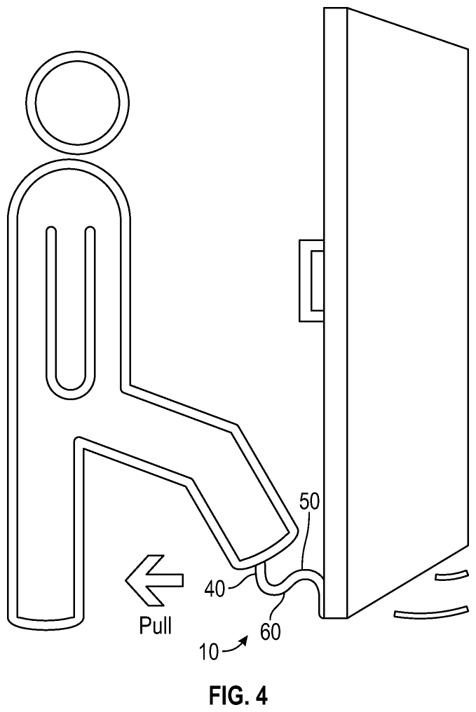

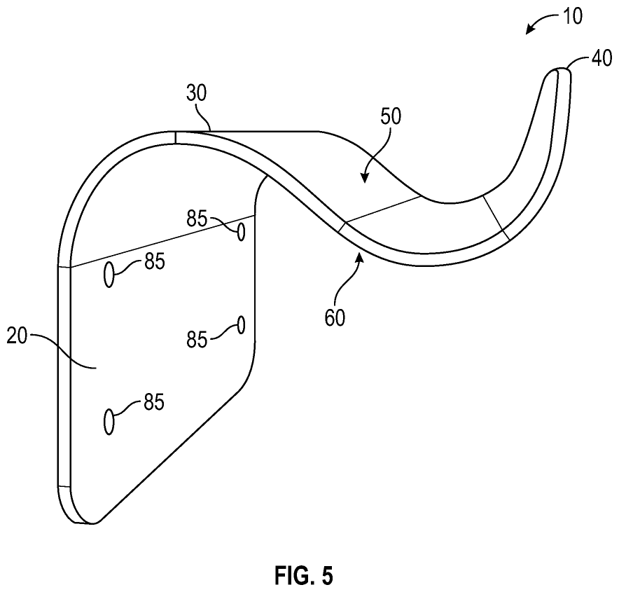

As shown in FIG. 3a, a user may use a top portion of the user's foot covering to engage bottom surface 60 and pull door 70 open or push the door closed. Alternatively, as shown in FIG. 3b, a user may use a bottom portion of a foot, covering, and/or outsole to engage top surface 50 and pull door 70 open or close. An illustration of a door opened using a bottom surface of a user's foot or foot covering is depicted in FIG. 4. Accordingly, embodiments of the present invention allow for comfortable use of door opener/closer/latch 10 when a user has on opened toed shoes or similar foot coverings that do not permit comfortable use of a top surface of the user's foot or foot covering. Embodiments may also have a first side surface 80 and a second side surface 90. First side surface 80 and second side surface 90 may be engaged by a side of a user's foot to either open door 70, or hold the door open after initially pulling it open or to close the door and then latch it when configured with the sliding track. See, e.g., FIGS. 3c and 3d. Side edge surfaces 85 and 95 may be engaged by a user. Accordingly, embodiments may be engaged at top surface 50, bottom surface 60, end 40, first side surface 80, second side surface 90 or side edge surfaces 85 and 95.

Embodiments of the present invention may also provide enhanced utility for users with various medical conditions. Embodiments having contact or engagement surfaces both on top surface 50 and bottom surface 60 permit utilization by users with varying medical limitations. For example, a user having a hip impairment or limitation can comfortably engage top surface 50 with a bottom surface of the user's foot or shoe, relying primarily on the user's knee and hamstring to pull door 70 open. Alternatively, a user having various knee ailments that may prohibit or limit bending of the knee can use a top portion of the user's foot or shoe to engage bottom surface 60 with a straight leg to pull door 70 open.

In addition to the sanitary and medical benefits of the present invention, embodiments may be employed as hands-free openers where a user is prohibited from using the user's hands to engage a door handle. For example, in a restaurant setting, a server, with trays in the server's hands, may use embodiments to open doors without putting the trays down.

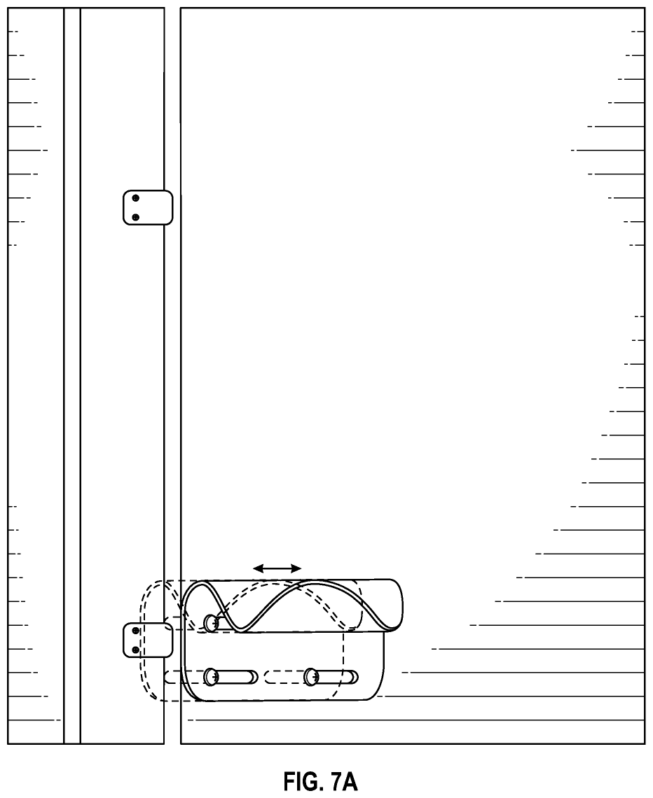

In other example embodiments, the door opener/closer/latch may be of varying dimensions and the dimensions may be adjusted for a chosen door. FIGS. 6a and 6b illustrate dimensions of an example embodiment of the present invention having a wave shaped extension 30.

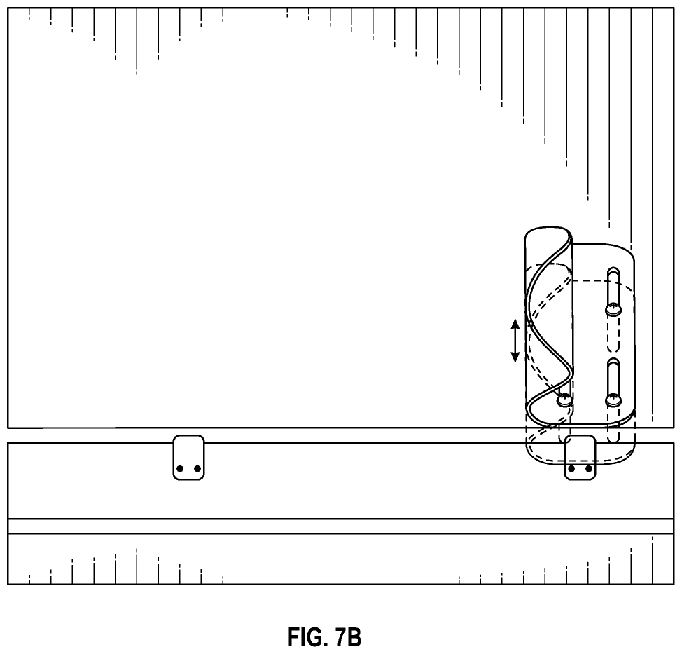

In the alternative embodiment of FIG. 7, the device is designed to traverse one or more lateral or vertical slots or tracks as would be formed if the device were mounted to a door with the attachment means (e.g., a set of screws of the like), so that the door opener/closer/latch preserves the variable flexibility of opening angles (so that the user can use the top, bottom, or side portion of their shoe or foot) while also admitting to a lateral or vertical repositioning of the device using only the foot so that the opener can engage neighboring hardware such as a locking mount installed on an existing partition such as a bathroom door or the like. In this manner, a latch, pin, or mated sliding piece engages and cooperates with the door opener/closer/latch so that the user can lock the door without having to touching the door with their hands.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A foot-operated door opener/closer/latch, comprising:
a single piece of material having a base member and an extension member;
wherein the base member is configured to be attachable to a bottom surface of a door;
wherein the extension member, which does not protrude below the bottom surface of the door, comprises a first portion arcing upwardly, a second portion arcing downwardly, and a third portion arcing upwardly, is configured to be engaged by a top, bottom or a side portion of a user's shoe such that when at least one of a downward, upward or sideward force is applied by said portion of said shoe, respectively, to said extension member, said door pulls open or closed;
and wherein said door opener/closer/latch is attachable to a door in such a manner that said door opener/closer/latch laterally traverses one or more tracks or grooves formed in the base member.

2. The door opener/closer/latch of claim 1, wherein the single piece of material is made from one of stainless steel, aluminum, copper, plastic, composite, and carbon fiber.

3. The door opener/closer/latch of claim 1, wherein the extension member further comprises a wave shape having top, bottom and side surfaces, each of said surfaces being of sufficient length and shape as to enable engagement from any angle.

4. The door opener/closer/latch of claim 1, wherein the extension member is configured to be engaged by the user's shoe at a top surface, a side surface, or a bottom surface of said extension member, wherein said top surface and said side surface each have a full 180 degree engagement surface that enables engagement by a user's shoe from any upper or side angle.

5. The door opener/closer/latch of claim 1, wherein the extension member is configured to be engaged by the user's shoe at a side surface of said extension member such that when a lateral force or a vertical force is applied to said side surface with said bottom portion of said shoe, said door pulls open or closes, wherein said lateral or vertical or side engagement is enabled anywhere along a 180 engagement surface of the third portion of the extension member or up and down on the top or bottom of same surface.

6. The door opener/closer/latch of claim 1, wherein the extension member is configured to be engaged by the user's shoe at a side surface of said extension member such that when a lateral or vertical force is applied to said side surface or top and bottom surface, the door opener/closer/latch traverses an associated track or groove, thereby achieving lateral or vertical displacement and admitting to engagement with a neighboring hardware installation.
